(19) United States
(12) Patent Application Publication
(10) Pub. No.: US 2002/0165334 A1
(43) Pub. Date: Nov. 7, 2002

(54) Aqueous dispersions

(76) Inventors: Martin Melchiors, Leichlingen (DE); Christoph Irle, Dormagen (DE); Joachim Petzoldt, Monheim (DE); Heino Muller, Leverkusen (DE)

Correspondence Address: BAYER CORPORATION, PATENT DEPARTMENT, 100 BAYER ROAD, PITTSBURGH, PA, 15205, US

(21) Appl. No.: 09/928,853

(22) Filed: Aug. 13, 2001

(30) Foreign Application Priority Data
Aug. 14, 2000 (DE) 10052875.9

(51) Int. Cl. C08G 18/00

(52) U.S. Cl. 528/44

(57) ABSTRACT

The invention relates to a waterborne coating composition containing a physical mixture present in the form of a dispersion in water and optionally organic solvents and containing

A at least one polyol having urethane groups and chemically bound hydrophilic groups, and

B at least one polyisocyanate having no chemically bound hydrophilic groups and which is blocked with pyrazole derivatives corresponding to formula (I)

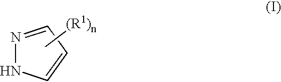

wherein R¹ represents a (cyclo)aliphatic hydrocarbon radical having 1 to 12, carbon atoms and wherein n is an integer from 0 to 3,

the molar ratio of blocked NCO groups of crosslinking agent B to NCO-reactive groups of polyol A or binder mixtures containing polyol A is 0.2:1 to 5:1.

for the production of chemical-resistant, chip-resistant and non-yellowing coatings.

### BACKGROUND OF THE INVENTION

The invention relates to waterborne coating compositions which are particularly suitable for the production of chemical-resistant, chip-resistant and non-yellowing coatings.

Chip-resistant coatings used in the automotive industry were mostly polyester resins in organic solvents which are stoved with melamine resins or blocked polyisocyanates as hardeners. A process for the preparation of such a stoving surfacer is described, e.g., in DE-A 3 918 510. An improvement in these systems is obtained by more highly developed surfacer coatings crosslinked with polyisocyanate (M. Bock, H. Casselmann, H. Blum “Progress in Development of Waterborne PUR Primers for the Automotive Industry”, Proc. Waterborne, Higher Solids and Powder Coatings Symp. New Orleans 1994).

Modern, waterborne binders are capable of replacing binders in organic solvents in many applications. For example, EP-A 0 427 028 describes water-dispersible binder combinations serving as a stoving surfacer, containing a dispersion of a urethane-modified polyester resin containing carboxylate groups and an aminoplastic resin and/or blocked polyisocyanate added to this dispersion, and optionally, an emulsifier. Alcohols, phenols, lactams and oximes are mentioned as blocking agents for the polyisocyanate.

In many applications for coatings of this kind, for example, in the automotive industry, the stringent requirements for the coating compounds and the resulting coatings are still not fully met. For example, a problem with the butanone oxime-blocked polyisocyanates predominantly used is that they turn yellow during the stoving process. Moreover, there is a desire for stoving binders with relatively high reactivity.

EP-A 0 159 117 describes polyisocyanates blocked with pyrazole derivatives which have greater reactivity compared with oximes and therefore crosslink at lower temperatures.

WO 97/12924 describes special water-dispersible polyisocyanates containing polyether or carboxylate groups and blocked with pyrazole derivatives. A disadvantage of the crosslinking agents described therein, however, is that such products are not storage-stable in an aqueous medium.

An object of the present invention was to provide waterborne coating compositions containing non-yellowing, storage-stable resins based on blocked polyisocyanate crosslinking agents. The object was achieved by the combination according to the invention. Surprisingly, it was found that polyisocyanates blocked with pyrazole derivatives can be dispersed in a stable manner in water with the aid of polyols containing urethane groups. In this case, the polyols according to the invention and containing urethane groups fulfil the function of an “emulsifier” for the polyisocyanates blocked with pyrazole derivatives. At the same time, however, the polyols containing urethane groups are reactants for the blocked polyisocyanates. After the blocking agent has been split off at elevated temperature, the OH groups crosslink with the functional groups of the polyisocyanate crosslinking agents then liberated.

### SUMMARY OF THE INVENTION

The invention relates to a waterborne coating composition containing a physical mixture present in the form of a dispersion in water and optionally organic solvents and containing

A at least one polyol having urethane groups and chemically bound hydrophilic groups, and

B at least one polyisocyanate having no chemically bound hydrophilic groups and which is blocked with pyrazole derivatives corresponding to formula (I)

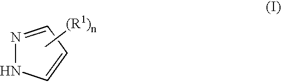

wherein R¹ represents a (cyclo)aliphatic hydrocarbon radical having 1 to 12, carbon atoms and wherein n is an integer from 0 to 3, and the molar ratio of blocked NCO groups of crosslinking agent B to NCO-reactive groups of polyol A or binder mixtures containing polyol A is 0.2:1 to 5:1.

### DETAILED DESCRIPTION OF THE INVENTION

The polyols A according to the invention containing urethane groups can be prepared from

A1 5% to 80%, preferably 10% to 60% of polyisocyanates

A2 10% to 80%, preferably 36% to 70% of polyols and/or polyamines with an average molecular weight Mₙ of at least 400,

A3 2% to 15%, preferably 3% to 10% of compounds which have at least two groups which are reactive towards isocyanate groups and at least one group capable of anion formation,

A4 0% to 20%, preferably 1% to 10% of low molecular weight polyols,

A5 0% to 20% of compounds which are monofunctional or contain active hydrogen of varying reactivity, these building blocks being situated in each case at the chain end of the polymer containing urethane groups, and/or

A6 0% to 20% of compounds which are different from A2, A3, A4 and A5 and contain at least two groups which are reactive towards NCO groups.

The polyols according to the invention containing urethane groups may be prepared, for example, from an isocyanate-functional prepolymer by reaction with compounds A5 and/or A6 to form an OH-functional compound. Suitable polyurethane resins include, e.g. those described in EP-A 0 355 682. The polyurethane resin containing OH groups can also be formed directly by reaction of components A1) to A6), as described, e.g., in EP-A 0 427 028.

The polyurethane resins used according to the invention generally have a number-average molecular weight Mₙ (calculated from the stoichiometry of the starting material) from 1,600 to 50,000, preferably 1,600 to 10,000, an acid value from 10 to 80, preferably 15 to 40, and a hydroxyl value from 16.5 to 200, preferably 30 to 130. It is at least water-dispersible in an alkaline medium and in low molecular weights is often even water-soluble under these conditions.

The polyisocyanates, preferably diisocyanates (A1) include the compounds well known in the field of polyurethanes and coatings, such as aliphatic, cycloaliphatic or aromatic diisocyanates. These preferably have the formula Q(NCO)₂ wherein Q represents a hydrocarbon radical having 4 to 40 carbon atoms, particularly 4 to 20 carbon atoms and preferably an aliphatic hydrocarbon radical having 4 to 12 carbon atoms, a cycloaliphatic hydrocarbon radical having 6 to 15 carbon atoms, an aromatic hydrocarbon radical having 6 to 15 carbon atoms, or an araliphatic hydrocarbon radical having 7 to 15 carbon atoms. Examples of such preferred diisocyanates include tetramethylene diisocyanate, hexamethylene diisocyanate, dodecamethylene diisocyanate, 1,4-diisocyanatocyclohexane, 3-isocyanatomethyl-3,5,5-trimethylcyclo-hexylisocyanate (isophorone diisocyanate), 4,4′-diisocyanatodicyclohexylmethane, 4,4′-diisocyanatodicyclohexylpropane-(2,2), 1,4-diisocyanatobenzene, 2,4- or 2,6-diisocyanatotoluene or mixtures of said isomers, 4,4′- or 2,4′-diisocyanatodiphenylmethane, 4,4′-diisocyanatodiphenylpropane-(2,2), p-xylylene diisocyanate and α,α,α′,α′-tetramethyl-m- or p-xylylene diisocyanate and mixtures of said compounds.

Apart from these simple polyisocyanates, those containing heteroatoms in the radical linking the isocyanate groups and/or having a functionality of more than 2 NCO groups per molecule are also suitable. Examples thereof include polyisocyanates containing carbodiimide groups, allophanate groups, isocyanurate groups, urethane groups, acylated urea groups or biuret groups, and 4-isocyanatomethyl-1,8-octane diisocyanate (nonane triisocyanate). DE-A 2 928 552 describes further suitable polyisocyanates. The proportion of polyisocyanates (A1) in the polyurethane resin is usually about 5 wt. % to 80 wt. %, preferably 10 wt. % to 60 wt. %, based on the polyurethane resin.

The polyols/polyamines according to (A2) preferably have a number-average molecular weight Mₙ from 400 to 5000, particularly from 800 to 2000. Their hydroxyl value or amine value is generally 22 to 400 mg/KOH/g, preferably 50 to 200 mg/KOH/g and particularly 80 to 160 mg/KOH/g. Examples of such polyols, include the compounds well known from polyurethane chemistry, like polyether polyols, polyester polyols, polycarbonate polyols, polyester amide polyols, polyamide polyols, epoxy resin polyols and the reaction products thereof with CO₂, polyacrylate polyols and similar compounds. Such polyols, which may also be used in mixture, are described, for example, in DE-A 2 020 905, DE-A 2 314 513 and DE-A 3 124 784 and in EP-A 0 120 466.

The polyether and polyester polyols are preferred, particularly those having only terminal OH groups and having a functionality of less than 3, preferably 2.8 to 2 and particularly 2. Examples of polyether polyols include polyoxyethylene polyols, polyoxypropylene polyols, polyoxybutylene polyols and preferably polytetrahydrofurans with terminal OH groups.

The polyester polyols particularly preferred according to the invention are the well known polycondensates of di- and optionally poly(tri, tetra)ols and di- and optionally poly(tri, tetra)carboxylic acids or hydroxycarboxylic acids or lactones. Instead of the free polycarboxylic acids, the corresponding polycarboxylic acid anhydride or corresponding polycarboxylic acid esters of lower alcohols may also be used for the preparation of the polyesters. Examples of suitable diols include ethylene glycol, butylene glycol, diethylene glycol, triethylene glycol, polyalkylene glycols such as polyethylene glycol, also propane diol, butane 1,4-diol, hexane 1,6-diol, neopentyl glycol or hydroxypivalic acid neopentylglycol ester. Hexane 1,6-diol, neopentyl glycol or hydroxypivalic acid neopentylglycol ester are preferred. Examples of polyols which may also optionally be used include trimethylolpropane, glycerol, erythritol, pentaerythritol, trimethylolbenzene or trishydroxyethylisocyanurate.

Instead of OH groups, the compounds of component A2) may also contain primary or secondary amino groups (wholly or as a proportion) as NCO-reactive groups.

Examples of suitable dicarboxylic acids include phthalic acid, isophthalic acid, terephthalic acid, tetrahydrophthalic acid, hexa-hydrophthalic acid, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, 2,2-dimethylsuccinic acid. Known anhydrides of these acids are also suitable. In the context of the present invention, the anhydrides are therefore covered by the term “acid”. Monocarboxylic acids such as benzoic acid and hexane carboxylic acid may also be used, provided that the average functionality of the polyol is greater than 2. Saturated aliphatic or aromatic acids are preferred, such as adipic acid or isophthalic acid. Trimellitic acid may be mentioned here as an example of a polycarboxylic acid to be used optionally in relatively small amounts.

The hydroxycarboxylic acids which may be used as a reactant in the preparation of a polyester polyol with terminal hydroxyl include for example, hydroxycaproic acid, hydroxybutyric acid, hydroxydecanoic acid, hydroxystearic acid and the like. Suitable lactones include caprolactone, butyrolactone and the like.

The amount of component (A2) in the polyurethane resin is usually from 10 wt. % to 80 wt. %, preferably 36 wt. % to 70 wt. %, based on the polyurethane resin.

Compounds suitable for the building block (A3) are described, for example, in US-A 3 412 054 and US-A 3 640 924 and in DE-A 2 624 442 and DE-A 2 744 544 hereby incorporated by reference. In particular, polyols, preferably diols, suitable for this purpose are those containing at least one carboxyl group, generally 1 to 3 carboxyl groups per molecule. Sulfonic acid groups are also suitable as groups capable of anion formation. Examples thereof include dihydroxycarboxylic acids such as α,α-dialkylolalkanoic acids, particularly α,α-dimethylolalkanoic acids such as 2,2-dimethylolacetic acid, 2,2-dimethylolpropionic acid, 2,2-dimethylolbutyric acid, 2,2-dimethylolpentanoic acid, dihydroxysuccinic acid, also polyhydroxy acids such as gluconic acid. 2,2-Dimethylol-propionic acid is particularly preferred. Compounds (A3) containing amino groups include, for example, α,δ-diaminovaleric acid, 2,4-diamino-toluenesulfonic acid-(5) and the like. Mixtures of said compounds (A3) may also be used. The amount of component (A3) in the polyurethane resin is generally 2 wt. % to 15 wt. %, preferably 3 wt. % to 10 wt. %, based on the polyurethane resin.

The low molecular weight polyols (A4) optionally used usually result in a stiffening of the polymer chain. They generally have a molecular weight from about 62 to 400, preferably 62 to 200. They may contain aliphatic, alicyclic or aromatic groups. Their amount is generally from 0 wt. % to 20 wt. %, preferably 1 wt. % to 10 wt. %, based on the polyol components (A2) to (A4). The low molecular weight polyols having up to about 20 carbon atoms per molecule include ethylene glycol, diethylene glycol, propane 1,2-diol, propane 1,3-diol, butane 1,4-diol, butylene 1,3-glycol, cyclohexane diol, 1,4-cyclohexane dimethanol, hexane 1,6-diol, bisphenol A (2,2-bis(4-hydroxyphenyl)propane), hydrogenated bisphenol A (2,2-bis(4-hydroxycyclohexyl)propane) and mixtures thereof, and as a triol, trimethylolpropane.

The polyurethane resin used according to the invention may also contain building blocks (A5) which are situated in each case at the chain ends and terminate said chains (chain stoppers). These building blocks can be derived from monofunctional compounds which react with NCO groups, such as monoamines, particularly monosecondary amines, or monoalcohols. Examples include: methylamine, ethylamine, propylamine, butylamine, octylamine, laurylamine, stearylamine, isononyloxy-propylamine, dimethylamine, diethylamine, dipropylamine, dibutylamine, N-methylaminopropylamine, diethyl(methyl)aminopropylamine, morpholine, piperidine and suitable substituted derivatives thereof, amide amines of diprimary amines and monocarboxylic acids, monoketimes of diprimary amines, primary/tertiary amines such as N,N-dimethylamino-propylamine and the like.

Preferred compounds for (A5) are those containing active hydrogen with varying reactivity towards NCO groups, such as compounds which, in addition to a primary amino group also contain secondary amino groups, or in addition to an OH group also contain COOH groups, or in addition to an amino group (primary or secondary) also contain OH groups, the latter being preferred. Examples thereof include: primary/secondary amines such as 3-amino-1-methylaminopropane, 3-amino-1-ethylaminopropane, 3-amino-1-cyclohexylaminopropane, 3-amino-1-methylaminobutane; mono-hydroxycarboxylic acids such as hydroxyacetic acid, lactic acid or malic acid, and also alkanolamines such as N-aminoethylethanolamine, ethanolamine, 3-aminopropanol, neopentanolamine and particularly preferably diethanolamine. In this way, functional groups are introduced in addition into the polymeric end product and this is thus rendered more reactive towards materials such as hardeners. The amounts of (A5) in the polyurethane resin are usually from 0 wt. % to 20 wt. %, preferably 0 wt. % to 10 wt. %, based on the polyurethane resin.

In addition to the building blocks according to (A5) or instead of these, the polyurethane resin according to the invention may also contain building blocks (A6) which are derived from so-called chain extenders, although this is less preferred. Suitable compounds include the compounds well known for this purpose which are reactive towards NCO groups and preferably difunctional, are not identical to (A2), (A3), (A4) and (A5) and mostly have average molecular weights of up to 400. Examples include water, hydrazine, adipic acid dihydrazide, poly(di)amines such as ethylene diamine, diethylene triamine, dimethylethylene diamine, diamino-propane, hexamethylene diamine, isophorone diamine, 4,4′-diamino-dicyclohexylmethane which may also bear substituents such as OH groups, and mixtures of the components mentioned. Such polyamines are described, for example, in DE-A 3 644 371. The amount (A6) in the polyurethane resin is usually from 0% to 20%, preferably 0% to 10%.

The polyurethane resin used according to the invention is prepared preferably by first preparing a polyurethane prepolymer from the polyisocyanates according to (A1), the polyols according to (A2) and optionally the low molecular weight polyols according to (A4) and the compounds according to (A3), said prepolymer containing on average at least 1.7, preferably 2 to 2.5 free isocyanate groups per molecule, then reacting said prepolymer with compounds according to (A5) and/or (A6) in a non-aqueous system, and then usually neutralizing the fully reacted polyurethane resin and converting it to an aqueous system. Optionally,Neutralization neutralization and the reaction with (A6) may also take place after conversion to the aqueous system.

The polyurethane prepolymer is prepared by the known method. The polyisocyanate is used in excess with respect to the polyols (A2) to (A4) so that a product with free isocyanate groups is obtained. These isocyanate groups are terminal and/or lateral, preferably terminal. Advantageously the equivalent ratio of isocyanate groups to the total number of OH groups in the polyols (A2) to (A4) is 1.05 to 1.4, preferably 1.1 to 1.3.

The reaction for the preparation of the prepolymer is normally carried out at temperatures from 60° C. to 140° C., depending on the reactivity of the isocyanate used. In order to accelerate the urethane formation reaction, suitable catalysts of the kind known to the skilled person for accelerating the NCO—OH reaction may be used. Examples include tert.-amines such as, e.g., triethylamine, organotin compounds such as, e.g., dibutyltin oxide, dibutyltin dilaurate or tin-bis(2-ethylhexanoate) or other organometal compounds. The urethane formation reaction is carried out preferably in the presence of solvents which are inert towards isocyanates. Suitable solvents include, in particular, those which are compatible with water such as the ethers, ketones and esters mentioned further below, and N-methylpyrrolidone. The amount of this solvent preferably does not exceed 20 wt. % and is preferably in the range from 5 wt. % to 15 wt. %, in each case based on the sum of polyurethane resin and solvent. Advantageously, the polyisocyanate is added slowly to the solution of the other components.

The prepolymer or solution thereof is then reacted with the compound according to (A5) and/or (A6), the temperature being advantageously in the range from 50° C. to 100° C., preferably from 60° C. to 90° C., until the NCO content in the prepolymer has practically fallen to zero. To this end, the compound (A5) is used in a less than stoichiometric amount or in a slight excess, the amounts being usually 40% to 110%, preferably 60% to 105% of the required stoichiometric amount. If less reactive diisocyanates are used to prepare the prepolymer, this reaction may also take place in water at the same time as neutralization neutralization. A part of the (non-neutralized) COOH groups, preferably 5% to 30%, may optionally be reacted with difunctional compounds which react with COOH groups, such as diepoxides.

The polyurethane resins according to the invention may also be prepared by reacting components (A1) to (A6) in a direct reaction to an OH-functional resin. The reaction conditions in this case correspond to the conditions described for the preparation of the prepolymer containing NCO groups.

In particular, tertiary amines are suitable for neutralizing the resulting product preferably containing COOH groups, e.g., trialkylamines having 1 to 12, preferably 1 to 6 carbon atoms in each alkyl radical. Examples thereof include trimethylamine, triethylamine, methyldiethy-lamine, tripropylamine and diisopropylethylamine. The alkyl radicals may also, for example, bear hydroxyl groups as in the case of dialkylmono-alkanolamine, alkyldialkanolamine and trialkanolamine. An example thereof is dimethylethanolamine which preferably serves as a neutralizing agent. Optionally, inorganic bases such as ammonia, or sodium or potassium hydroxide may also be used as neutralizing agents. The neutralizing agent is usually used in a molar ratio to the COOH groups of the prepolymer of about 0.3:1 to 1.3:1, preferably about 0.5:1 to 1:1.

Neutralization of the COOH groups may take place before, during or after the urethane formation reaction. The neutralization step is carried out preferably after the urethane formation reaction, usually at a temperature from room temperature to 80° C., preferably 40° C. to 80° C. It may be carried out in any manner, e.g., in such a way that the water-containing neutralizing agent is added to the polyurethane resin or vice versa. It is also possible, however, to add the neutralizing agent to the polyurethane resin first and only then to add the water. Solid contents from 20% to 70%, preferably 30% to 50% can be obtained in this way.

A mixture of several polyols A containing urethane groups and suitable according to the invention may also be used, The polyurethane resin (100%) content in the waterborne coating composition is generally from 5 wt. % to 60 wt. % preferably from 10 wt. % to 40 wt. %, based on the total composition.

Apart from the polyurethane resin, the waterborne surfacer composition may also contain, as a binder, up to 60 wt. %, preferably up to 30 wt. %, based on the polyurethane resin, of other oligomeric or polymeric materials such as crosslinkable, water-soluble or water-dispersible phenolic resins, polyester resins, epoxy resins or acrylic resins etc., as described, for example, in EP-A 0 089 497.

Component B is a polyisocyanate which contains no chemically bound hydrophilic groups and which is blocked with pyrazole derivatives corresponding to formula (I)

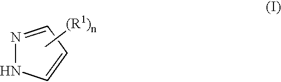

wherein R¹ represents one or more (cyclo)aliphatic hydrocarbon radicals in each case having 1 to 12, preferably 1 to 4 carbon atoms and in which n may be an integer from 0 to 3, preferably 1 or 2. Examples of such blocking agents include 3,5-dimethylpyrazole or 3-methylpyrazole; 3,5-dimethylpyrazole is particularly preferred.

The polyisocyanates on which component B is based and the NCO groups of which are blocked with the pyrazole derivative are organic polyisocyanates with an average NCO functionality of at least 2 and a molecular weight of at least 140 g/mole. Highly suitable examples are mainly (i) unmodified organic polyisocyanates in the molecular weight range from 140 g/mole to 300 g/mole and (ii) paint polyisocyanates in a molecular weight range from 300 g/mole to 1,000 g/mole. In principle, NCO prepolymers containing urethane groups (iii) with a molecular weight above 1,000 g/mole are also suitable in so far as they contain no groups causing the water-dispersibility of the polyisocyanate. Of course, mixtures of (i) to (iii) are also suitable.

Examples of polyisocyanates of group (i) include 1,4-diisocyanatobutane, 1,6-diisocyanatohexane (HDI), 1 ,5-diisocyanato-2,2-dimethylpentane, 2,2,4- and 2,4,4-trimethyl-1,6-diisocyanatohexane, 1-isocyanato-3,3,5-trimethyl-5-isocyanatomethyl-cyclohexane (IPDI), 1-isocyanato-1-methyl-4-(3)-isocyanatomethylcyclohexane, bis-(4-isocyanatocyclohexyl)methane), 1,10-diisocyanatodecane, 1,12-diisocyanatodecane, cyclohexane-1,3- and 1,4-diisocyanate, 4-isocyanatomethyl-1,8-octane diisocyanate (nonane triisocyanate), xylylene diisocyanate isomers, 2,4-diisocyanatotoluene or mixtures thereof with 2,6-diisocyanatotoluene with preferably up to 35 wt. %, based on mixture, of 2,6-diisocyanatotoluene, 2,2′-, 2,4′-, 4,4′-diisocyanatodiphenylmethane or technical polyisocyanate mixtures of the diphenylmethane series or any mixtures of the isocyanates mentioned.

Polyisocyanates of group (ii) are the inherently well known paint polyisocyanates. The term “paint polyisocyanates” within the scope of the invention means compounds or mixtures of compounds which are obtained by inherently known oligomerization reactions of simple diisocyanates of the type mentioned by way of example under (i). Suitable oligomerization reactions include, e.g., carbodiimide formation, dimerisation, trimerisation, biuret formation, urea formation, urethane formation, allophanate formation and/or cyclisation with the formation of oxadiazine structures. Often, several of the reactions mentioned take place simultaneously or successively during “oligomerization”. The “paint polyisocyanates” are preferably a) biuret polyisocyanates, b) polyisocyanates containing isocyanurate groups, c) polyisocyanate mixtures containing isocyanurate and uretdione groups, d) polyisocyanates containing urethane and/or allophanate groups, or e) polyisocyanate mixtures containing isocyanurate and allophanate groups and based on simple diisocyanates. The preparation of such paint polyisocyanates is well known and described, for example, in DE-A 1 595 273, DE-A 3 700 209 and DE-A 3 900 053 or in EP-A 0 330 966, EP-A 0 259 233, EP-A 0 377 177, EP-A 0 496 208, EP-A 0 524 501 and US-A 4 385 171.

The preparation of component B from polyisocyanate and pyrazole derivatives is carried out by methods known in the art and is described, e.g., in EP-A0 159 117.

It is also possible to use a mixture of several suitable crosslinking agents B . It is also possible to use a suitable crosslinking agent B in mixture with a crosslinking agent (B2), wherein the weight proportion of said additional crosslinking agent may be at most 50% of the sum (B+B2), in each case based on solid resin. Suitable crosslinking agents B2 include e.g. blocked polyisocyanates different from B, melamine resins or carbamates.

In order to prepare the waterborne coating compositions according to the invention, component B is added to resin A before or during the conversion thereof to the aqueous phase. Components A and B are preferably mixed before conversion to the aqueous phase and the mixture thus obtained is then dispersed in water. The polyol resin A then serves as an emulsifier for the non hydrophilically modified crosslinking agent B and thus keeps the latter stable in the aqueous dispersion. Depending on the formulation of the polyol resin, a chain extension step (with component A6) in the aqueous dispersion may follow.

The amount of component B is calculated such that the molar ratio of blocked NCO groups of B to NCO-reactive groups of A is 0.2:1 to 5:1, preferably 0.3:1 to 3:1.

The aqueous composition according to the invention, the pH of which is usually in the range from 6.0 to 10.0, preferably 6.8 to 8.5, may also contain the conventional paint additives such as pigments and fillers and paint auxiliary substances, e.g., anti-settling agents, defoamers and/or wetting agents, flow promoters, reactive thinners, plasticisers, catalysts, auxiliary solvents, thickeners and the like. At least a part of these additives may be added to the composition immediately before processing, but it is also possible to add at least part of the additives before or during dispersion of the binder or binder/crosslinking agent mixture. The choice and addition of these substances, which may be added to the individual components and/or to the total mixture, are well known to the skilled person.

Examples of suitable pigments include iron oxides, lead oxides, lead silicates, titanium dioxide, barium sulfate, zinc oxide, zinc sulfide, phthalocyanine complexes etc. and suitable fillers include mica, kaolin, chalk, quartz flour, asbestos flour, slate powder, various silicas, silicates and talc, including so-called microtalc, with a particle size of max 10 μ (cf. EP-A 0 249 727). These pigments and/or fillers are usually used in amounts from 10 wt. % to 70 wt. %, preferably from 30 wt. % to 50 wt. %, based on the total solids content of the surfacer composition.

Suitable catalysts in this case include p-toluenesulfonic acid, dodecylbenzenesulfonic acid etc.

The auxiliary solvents, for example, ethers such as dimethyl(diethyl)glycol, dimethyl(diethyl)diglycol, tetrahydrofuran, ketones such as methyl ethyl ketone, acetone, cyclohexanone, esters such as butyl acetate, ethyl glycol acetate, methyl glycol acetate, methoxypropyl acetate, alcohols such as ethanol, propanol, butanol, are used only in the smallest possible amount, if at all, for reasons of environmental compatibility, said amount not usually exceeding 10 wt. %, preferably 1 wt. % to 5 wt. %, based on water (as the main diluent). The amount of water in the aqueous composition is usually 15 wt. % to 80 wt. %, preferably 30 wt. % to 60 wt. %, based on the total composition.

The waterborne coating compositions are prepared by conventional methods of coating production as can be seen, for example, from the formulations given further below.

The waterborne coating compositions, the total solids content of which is generally 35 wt. % to 75 wt. %, preferably 40 wt. % to 60 wt. %, are applied in a known manner, for example, by spraying using the compressed air process or by airless or electrostatic spraying. Temperatures from 100° C. to 200° C., preferably 120° C. to 160° C. are generally used to cure the surfacer films applied. The curing time is generally 10 to 60 minutes, preferably 15 to 45 minutes.

The crosslinked surfacer coatings thus obtained are characterised in particular by improved stone chip resistance at low temperatures (0° C. to −30° C.) and by good inter-layer adhesion. Moreover, they have good elongation at break and excellent impact strength. Resistance to atmospheric moisture and solvents is also very good.

The examples below explain the invention. Unless otherwise specified, details in percent are percent by weight (wt. %).

Blocked Polyisocyanate B1

1250 g of Desmodur N 3300 (aliphatic polyisocyanate based on hexamethylene diisocyanate, Bayer AG), 208 g of 1-methoxypro-pylacetate-2 and 418 g of Solventnaphtha 100 (Shell) were heated to 50° C. 628 g of 3,5-dimethylpyrazole were added in such a way, with stirring, that the temperature did not exceed 65° C. Stirring was then continued at 50° C. until no more isocyanate could be detected by IR spectroscopy.

Blocked Polyisocyanate B2

998 g of Desmodur® N 3300 (aliphatic polyisocyanate based on hexamethylene diisocyanate, Bayer AG) and 500 g of N-methylpyrrolidone were heated to 50° C. 502 g of 3,5-dimethylpyrazole were added in such a way, with stirring, that the temperature did not exceed 65° C. Stirring was then continued at 50° C. until no more isocyanate could be detected by IR spectroscopy.

Blocked Polyisocyanate B3

HDI-based hydrophilically modified polyisocyanate blocked with butanone oxime, with an NCO content (blocked) of 7.2%, 67.5% solution in NMP (Bayhydur VP LS 2186, Bayer AG).

Blocked Polyisocyanate B4

Hydrophilic polyisocyanate based on hexamethylene diisocyanate and blocked with 3,5-dimethylpyrazole, according to example 2 of WO 97/12924 with an NCO content (blocked) of 4.75%, 40% dispersion in water/NMP/dimethylaminopropanol 52:6:2.

### EXAMPLE D1

Aqueous Dispersion of Polyol Containing Urethane Groups and Blocked Polyisocyanate

266 g of Desmophen C200 (linear, aliphatic polycarbonate polyester, hydroxyl value 66 mg KOH/g), 266 g of Desmophen VP LS 2236 (linear, aliphatic polycarbonate polyester, hydroxyl value 112 mg KOH/g), 27 g of dimethylolpropionic acid and 214 g of N-methylpyrrolidone were heated to 70° C. and stirred until a clear solution had formed. 185 g of 4,4′-diisocyanatodicyclohexylmethane were then added. An exothermic reaction commenced. The mixture was kept at 100° C. until the NCO content was 1.9 wt. %.

The mixture was then cooled to 70° C. and 21 g of triethylamine, 255 g of the blocked polyisocyanate of Example B1 and 18 g of the reaction product of 1 mole of nonyl phenol and 20 mole of ethylene oxide were added and homogenization was carried out by stirring for 10 minutes. 900 g of the resin solution thus prepared were then dispersed, with stirring, in 930 g of water at 23° C., with stirring. Stirring was continued for a further 5 min, then a solution of 31 g of diethanolamine in 103 g of water was added within a period of 5 min. The dispersion was stirred at room temperature until no more isocyanate could be detected (IR spectroscopy).

The product was a polyurethane dispersion with an average particle size of 60 nm (determined by laser correlation spectroscopy).

### EXAMPLE D2

Aqueous Dispersion of Polyol Containing Urethane Groups and Blocked Polyisocyanate

Example D1 was repeated except that 255 g of the blocked polyisocyanate B2 were added instead of polyisocyanate B1. The polyurethane dispersion obtained had an average particle size of 38 nm (determined by laser correlation spectroscopy).

### EXAMPLE D3

(Not According to the Invention)

Aqueous Dispersion of Polyol Containing Urethane Groups and Blocked Polyisocyanate

266 g of Desmophen C200 (linear, aliphatic polycarbonate polyester, hydroxyl value 66 mg KOH/g), 266 g of Desmophen VP LS 2236 (linear, aliphatic polycarbonate polyester, hydroxyl value 112 mg KOH/g), 27 g of dimethylolpropionic acid and 214 g of N-methylpyrrolidone were heated to 70° C. and stirred until a clear solution had formed. 185 g of 4,4′-diisocyanatodicyclohexylmethane were then added. An exothermic reaction commenced. The mixture was kept at 100° C. until the NCO content was 1.9 wt. %.

The mixture was then cooled to 70° C. and 21 g of triethylamine and 18 g of the reaction product of 1 mole of nonyl phenol and 20 mole of ethylene oxide were added and homogenization was carried out by stirring for 10 minutes. 700 g of the resin solution thus prepared were then dispersed, with stirring, in 723 g of water at 23° C., with stirring. Stirring was continued for a further 5 min, then a solution of 24 g of diethanolamine in 80 g of water was added within a period of 5 min. The dispersion was stirred at room temperature until no more isocyanate could be detected (IR spectroscopy).

The product was a polyurethane dispersion with an average particle size of 23 nm (determined by laser correlation spectroscopy) and a solids content of 35.8%.

202 g of hydrophilically modified, blocked polyisocyanate B4 were added to 929 g of this dispersion, with stirring, at room temperature. A dispersion with an average particle size of 24 nm was obtained.

### EXAMPLE D4

Aqueous Dispersion of Polyol Containing Urethane Groups and Blocked Polyisocyanate

192 g of a polyester of adipic acid and hexane diol (OH value 69 mg KOH/g), 21 g of dimethylolpropionic acid, 41 g of hexane 1,6-diol and 214 g of N-methylpyrrolidone were heated to 70° C. and stirred until a clear solution had formed. 196 g of isophorone diisocyanate were then added. An exothermic reaction commenced. The mixture was kept for 1 h at 80° C. and then heated to 100° C. and kept at 10° C. until the NCO content was 4.0 wt. %.

The mixture was then cooled to 70° C. and 16 g of triethylamine, 323 g of the blocked polyisocyanate from Example B1 and 15 g of the reaction product of 1 mole of nonyl phenol and 20 mole of ethylene oxide were added and homogenization was carried by stirring for 10 minutes. 700 g of the resin solution thus prepared were then dispersed, with stirring, in 853 g of water at 35° C., with stirring. Stirring was continued for a further 5 minutes, then a solution of 38 g of diethanolamine in 195 g of water was added within a period of 5 min. The dispersion was stirred at room temperature until no more isocyanate could be detected (IR spectroscopy).

The product was a polyurethane dispersion with an average particle size of 54 nm (determined by laser correlation spectroscopy).

### EXAMPLE D5

Aqueous Dispersion of Polyol Containing Urethane Groups and Blocked Polyisocyanate

2156 g of a polyester with an OH content of 5.2% and an acid value of 2 mg KOH/g containing 30.7% of hexane 1,6-diol, 17.0% of trimethylolpropane, 6.1% of soya oil fatty acid, 24.6% of isophthalic acid and 21.6% of adipic acid were charged to a 4 l reaction vessel with a cooling, heating and stirring device and heated to 130° C. together with 188 g of dimethylolpropionic acid, 48 g of trimethylolpropane, 448 g of N-methylpyrrolidone and 7.5 g of tin octoate and homogenized for 30 min. The mixture was then cooled to 80° C. and 609 g of 1-isocyanato-3,3,5-trimethyl-5-isocyanatomethylcyclohexane (IPDI) were added with vigorous stirring, the mixture was heated to 130° C. (using the exothermic nature of the reaction) and was kept at this temperature until no more NCO groups could be detected.

The resin melt then had a viscosity of 66 seconds, determined as the flow time of a 40% xylene solution in a DIN 4 cup at 23° C.

307 g of the blocked polyisocyanate B1 were then added to 1000 g of this resin melt at 75° C., the mixture was homogenized for 20 min at this temperature and 25.3 g of dimethylethanolamine were added. Stirring was continued for 10 min at 75° C. and then 1050 g of dist. water were added slowly. The dispersion obtained had a solids content of 44.4%, a co-solvent content of 8.3%, a viscosity of 1260 mPas and an average particle size of 60 nm. The acid value was 23.4 mg KOH/g, the OH content 2.4% (in each case based on 100% solids content).

### EXAMPLE D6

Aqueous Dispersion of Polyol Containing Urethane Groups and Blocked Polyisocyanate

614 g of the blocked polyisocyanate B1 were added to 1000 g of the resin melt from Example D5 at 75° C., the mixture was homogenized for 20 min at this temperature and 25.3 g of dimethylethanolamine were added. Stirring was continued for 10 min at 75° C. and then 1200 g of dist. water were added slowly. The dispersion obtained had a solids content of 45.7%, a co-solvent content of 9.8%, a viscosity of 800 mPas and an average particle size of 90 nm. The acid value was 20 mg KOH/g, the OH content 2.0% (in each case based on 100% solids content).

### EXAMPLE D7

Aqueous Dispersion of Polyol Containing Urethane Groups and Blocked Polyisocyanate

1119 g of a polyester with an OH content of 3.3% and an acid value of 3 mg KOH/g containing 39.7% of neopentyl glycol, 6.4% of trimethylolpropane, 43.5% of tetrahydrophthalic anhydride and 10.4% of adipic acid, and 1119 g of a polyester of 30.4% of hexane 1,6-diol, 16.9% of neopentyl glycol and 52.7% of adipic acid (OH content 2.0%, acid value about 1 mg KOH/g) were charged to a 4 l reaction vessel with a cooling, heating and stirring device and heated to 130° C. together with 150 g of dimethylolpropionic acid, 138 g of trimethylol propane, 333 g of N-methylpyrrolidone and 3.8 g of tin octoate and homogenized for 30 min. The mixture was then cooled to 90° C. and 474 g of 1-isocyanato-3,3,5-trimethyl-5-isocyanatomethylcyclohexane (IPDI) were then added with vigorous stirring, the mixture was heated to 130° C. (using the exothermic nature of the reaction) and kept at this temperature until no more NCO groups could be detected.

The resin melt then had a viscosity of 55 seconds, determined as the flow time of a 50% solution in methoxypropyl acetate in a DIN 4 cup at 23° C.

286 g of the blocked polyisocyanate B1 were then added to 1000 g of this resin melt at 70° C., the mixture was homogenized for 30 min at this temperature and 29.9 g of dimethylethanolamine were added. Stirring was continued for 15 min at 70° C. and then 950 g of dist. water were added slowly.

The dispersion obtained had a solids content of 48.3%, a co-solvent content of 7.4%, a viscosity of 1340 mPas and an average particle size of 62 nm. The acid value was 20 mg KOH/g, the OH content 2.2% (in each case based on 100% solids content).

### EXAMPLE D8

Aqueous Dispersion of Polyol Containing Urethane Groups and Blocked Polyisocyanate

571 g of the blocked polyisocyanate B1 were added to 1000 g of the resin melt from Example D7 at 70° C., the mixture was homogenized for 30 min at this temperature and 29.9 g of dimethylethanolamine were added. Stirring was continued for 15 min at 70° C. and then 1085 g of dist. water were added slowly.

The dispersion obtained had a solids content of 48.2%, a co-solvent content of 8.8%, a viscosity of 730 mPas and an average particle size of 90 nm. The acid value was 17 mg KOH/g, the OH content 1.8% (in each case based on 100% solids content).

### EXAMPLE D9

Aqueous Dispersion of Polyol Containing Urethane Groups and Blocked Polyisocyanate

2478 g of a polyester with an OH content of 5.4% and an acid value of 3 mg KOH/g containing 2.0% of propylene glycol, 35.0% of neopentyl glycol, 10.4% of trimethylolpropane, 30.0% of isophthalic acid and 22.6% of adipic acid were charged to a 4 l reaction vessel with a cooling, heating and stirring device and heated to 130° C. together with 150 g of dimethylolpropionic acid, 125 g of N-methylpyrrolidone and 3.8 g of tin octoate and homogenized for 30 min. The mixture was then cooled to 100° C. and 372 g of hexamethylene diisocyanate (HDI) were added with vigorous stirring, the mixture was heated to 130° C. (using the exothermic nature of the reaction) and kept at this temperature until no more NCO groups could be detected.

The resin melt then had a viscosity of 121 seconds, determined as the flow time of a 50% xylene solution in a DIN 4 cup at 23° C.

336 g of the blocked polyisocyanate B1 were then added to 900 g of this resin melt at 65° C., the mixture was homogenized for 20 min at this temperature and 28.7 g of dimethylethanolamine were added. Stirring was continued for 10 min at 65° C. and then 1230 g of dist. water were added slowly.

The dispersion obtained had a solids content of 43.8%, a co-solvent content of 4.7%, a viscosity of 840 mPas and an average particle size of 80 nm. The acid value was 19.6 mg KOH/g, the OH content 2.6% (in each case based on 100% solids content).

### EXAMPLE D10

Aqueous Dispersion of Polyol Containing Urethane Groups and Blocked Polyisocyanate

672 g of the blocked polyisocyanate B1 were added to 900 g of the resin melt from Example D9 at 65° C., the mixture was homogenized for 20 min at this temperature and 28.7 g of dimethylethanolamine were added. Stirring was continued for 10 min at 65° C. and then 1250 g of dist. water were added slowly.

The dispersion obtained had a solids content of 46.5%, a co-solvent content of 6.9%, a viscosity of 1000 mPas and an average particle size of 150 nm. The acid value was 16 mg KOH/g, the OH content 2.1% (in each case based on 100% solids content).

### EXAMPLE D11

(Not According to the Invention)

Aqueous Dispersion of Polyol Containing Urethane Groups

2156 g of a polyester with an OH content of 5.2% and an acid value of 2 mg KOH/g containing 30.7% of hexane 1,6-diol, 17.0% of trimethylolpropane, 6.1% of soya oil fatty acid, 24.6% of isophthalic acid and 21.6% of adipic acid were charged to a 4 l reaction vessel with a cooling, heating and stirring device and heated to 130° C. together with 188 g of dimethylolpropionic acid, 48 g of trimethylolpropane, 448 g of N-methylpyrrolidone and 7.5 g of tin octoate and homogenized for 30 min. The mixture was then cooled to 80° C. and 609 g of 1-isocyanato-3,3,5-trimethyl-5-isocyanatomethylcyclohexane (IPDI) were added with vigorous stirring, the mixture was heated to 130° C. (using the exothermic nature of the reaction) and kept at this temperature until no more NCO groups could be detected.

The resin melt then had a viscosity, determined as the flow time of a 40% xylene solution in a DIN 4 cup at 23° C., of 66 seconds.

25.3 g of dimethylethanolamine were then added to 1000 g of this resin melt at 90° C. The mixture was stirred at 90° C. for 10 min and then 850 g of dist. water were added slowly. The dispersion obtained had a solids content of 46.6%, a co-solvent content of 7.0%, a viscosity of 1900 mPas and an average particle size of 42 nm. The acid value was 28 mg KOH/g, the OH content 3.0% (in each case based on 100% solids content).

### EXAMPLE D12

(Not According to the Invention)

Aqueous Dispersion of Polyol Containing Urethane Groups and Blocked Polyisocyanate B4

2478 g of a polyester with an OH content of 5.4% and an acid value of 3 mg KOH/g containing 2.0% of propylene glycol, 35.0% of neopentyl glycol, 10.4% of trimethylolpropane, 30.0% of isophthalic acid and 22.6% of adipic acid were charged to a 4 l reaction vessel with a cooling, heating and stirring device and heated to 130° C. together with 150 g of dimethylolpropionic acid, 125 g of N-methylpyrrolidone and 3.8 g of tin octoate and homogenized for 30 min. The mixture was then cooled to 100° C. and 372 g of hexamethylene diisocyanate (HDI) were added with vigorous stirring, the mixture was heated to 130° C. (using the exothermic nature of the reaction) and kept at this temperature until no more NCO groups could be detected. The resin melt then had a viscosity of 121 seconds, determined as the flow time of a 50% xylene solution in a DIN 4 cup at 23° C.

28.7 g of dimethylethanolamine were then added to 900 g of this resin melt at 80° C. The mixture was stirred for 15 min at 80° C. and then 828 g of dist. water were added slowly. The dispersion obtained had a solids content of 45.0%, a co-solvent content of 1.9%, a viscosity of 1630 mPas and an average particle size of 32 nm. The acid value was 22 mg KOH/g, the OH content 3.3% (in each case based on 100% solids content).

319 g of the hydrophilically modified blocked polyisocyanate B4 were added to 800 g of this dispersion at room temperature, with stirring. A dispersion with an average particle size of 27 nm was obtained.

### EXAMPLE A1

Testing the Dispersions Containing Crosslinking Agent for Storage Stability

TABLE 1

| | | | D12 |
|---|---|---|---|
| | | | Not according to the |
| Dispersion | D9 | D10 | invention |
| NCO (blocked): OH | 0.5:1 | 1:1 | 0.5:1 |
| Starting values: | | | |
| Viscosity [D = 40s⁻¹, | 1000 | 840 | 480 mPas |
| 23° C.] | mPas | mPas | |
| Ave. particle size | 52 nm | 149 nm | 26 nm |
| pH | 7.8 | 7.8 | 8.1 |
| After 4 weeks 40° C: | | | |
| Viscosity [D = 40s⁻¹, | 930 mPas | 560 | 70 mPas pressure build-up |
| 23° C.] | | mPas | |
| Ave. particle size | 48 nm | 140 nm | 36 nm |
| pH | 7.5 | 7.4 | 7.5 |
| After 4 weeks 50° C: | | | |
| Viscosity [D = 40s⁻¹, | 640 mPas | 390 | <20 mPas |
| 23° C.] | | mPas | pressure build-up |
| | | | sediment formation |
| Ave. particle size | 60 nm | 160 nm | 90 nm |
| pH | 7.3 | 7.2 | 7.1 |

All 3 dispersions containing crosslinking agent in Table 1 contain the same polyol dispersion containing urethane groups. It can be seen that the self-crosslinking dispersions D9 and D10 according to the invention are sufficiently stable in storage, even with twice the crosslinking agent content (D10), whereas with the dispersions D12 not according to the invention the viscosity falls rapidly during storage, the particles of the dispersion become coarser and gas evolution (pressure build-up) is ascertained. After 4 weeks' storage at 50° C., a sediment also starts to form in D12.

### EXAMPLE A2

Use of the Self-crosslinking Resin Dispersions as Clear Coats (According to the Invention)

196.5 parts by wt. of the dispersions according to Examples D1-D10 were formulated to a waterborne clear coat with 3.5 parts by wt. of a commercial flow promoter (Additol XW 395, Vianova Resins), applied to glass sheets (wet film thickness 120 μm), allowed to dry for 10 min at room temperature and then stoved for 30 min at 140° C. and 160° C. Table 2 shows the results of the paint tests.

### EXAMPLE A3

Comparison Example to A2): Not According to the Invention

158.5 parts by wt. of the dispersions according to Example D11 were formulated to a waterborne clear coat with 38 parts by weight of polyisocyanate B3, 3.5 parts by wt. of a commercial flow promoter (Additol XW 395, Vianova Resins) and 57 parts by wt. of dist. water, applied to a glass plate (wet film thickness 120 μm), allowed to dry for 10 min at room temperature and then stoved for 30 min at 140° C. and 160° C. Table 2 shows the results of the paint tests.

TABLE 2
Paint properties of the clear coats prepared according to Example A2 and A3

| | | | | | | | |
|---|---|---|---|---|---|---|---|
| Example of appl. | A2 | A2 | A2 | A2 | A2 | A2 | A3 |
| Dispersion from Example: | D1 | D4 | D5 | D6 | D9 | D10 | D11 (comparison) |

Drying 10 min RT + 30 min 140° C.:

| | | | | | | | |
|---|---|---|---|---|---|---|---|
| Appearance of | Satisf. | Satisf. | Satisf. | Satisf. | Satist. | Satisf. | Satisf. |
| paint film | | | | | | | |
| Pendulum | 41 | 134 | 73 | 113 | 74 | 138 | 57 |
| hardness | | | | | | | |
| Solvent | 2234 | 1014 | 4244 | 2144 | 3344 | 2144 | 4344 |
| resistance | | | | | | | |

Drying 10 min RT + 30 min 160° C.:

| | | | | | | | |
|---|---|---|---|---|---|---|---|
| Appearance of | Satisf. | Satisf. | Satisf. | Satisf. | Satisf. | Satisf. | Satisf. |
| film | | | | | | | |
| Pendulum | 40 | 143 | 82 | 154 | 80 | 178 | 76 |
| hardness | | | | | | | |
| Solvent | 2222 | 1022 | 4244 | 2024 | 3244 | 2124 | 4344 |
| resistance | | | | | | | |

Coatings based on dispersions according to the invention according to Ex. 2 exhibit greater resistance to solvents compared with Ex. A3 and in some cases markedly greater film hardness.

### EXAMPLE A4

Use of the Self-crosslinking Resin Dispersions as Waterborne Stoving Surfacers (According to the Invention)

a) Preparation of a pigment paste P

A predispersed slurry composed of 10.8 g of 70% water-thinnable polyester resin (Bayhydrol D 270, Bayer AG), 21.1 g of dist. water, 1.5 g of 10% dimethylethanolamine in water and 2.8 g of commercial wetting agent, 27.7 g of titanium dioxide (Tronox R-FD-I, Kerr McGee Pigments GmbH & Co KG), 0.3 g of black iron oxide (Bayferrox 303 T), 27.9 g of barium sulfate (blanc fixe Micro, Sachtleben GmbH), 6.8 g of talc (Micro Talc IT Extra, Norwegian Talc) and 1.0 g of antisettling agent (Aerosil R 972 Degussa) was ground to a paste for 30 minutes in a commercial pearl mill, with cooling.

b) Preparation of a waterborne stoving surfacer

32 parts by wt. of the dispersions according to Ex. D5, D6, D9, D10 were ground to a paste with 40 parts by wt. of the pigment paste P described above, 6 parts by wt. of a commercial polyester dispersion (Bayhydrol D 270, Bayer AG), 3.4 parts by wt. of a commercial melamine resin (Maprenal MF 904, Vianova Resins) and adjusted to a pH of 8.5±0.5 with 9-16 parts by wt. of dist. water and 0-2 parts by wt. of a 10% aqueous solution of dimethylethanolamine and to a flow time of 35±5 seconds at 23° C. in the DIN5 cup.

These coatings were applied by means of flow cup spray gun with a nozzle diameter of 1.5 mm and an atomisation pressure of 5 bar to the substrates listed below in a resulting dry film thickness of 25 μm to 35 μm. The resulting wet coating films were allowed to dry at room temperature and then stoved in a circulating air oven for 25 min at 165° C. The substrates were glass sheets in the case of the pendulum hardness, partial dissolution and gloss tests, degreased steel sheets in the case of the Erichsen indentation test and, in the case of the stone chip tests, steel sheets coated by cathodic electrodeposition which are used in automobile production. Table 3 shows the results of the paint tests.

A part of the sheets coated with the surfacer and stoved was then coated with a commercial 1-pack acrylate/melamine top coat “Flash Red” from DuPont/Herberts and stoved for 30 min at 130° C. The paint test results are also contained in Table 3.

### EXAMPLE A5

Comparison Example to A4); Not According to the Invention

23 parts by wt. of the dispersions according to Ex.D11 were ground to a paste with 40 parts by wt. of the pigment paste P1, 6 parts by wt. of a commercial polyester dispersion (Bayhydrol D 270, Bayer AG), 3.4 parts by wt. of a commercial melamine resin (Maprenal MF 904, Vianova Resins) and 5.5 parts by wt. of polyisocyanate B3 and adjusted to a pH of 8.5±0.5 with 16 parts by wt. of dist. water and 0.5 parts by wt. of a 10% aqueous solution of dimethylethanolamine and to a flow time of 35±5 seconds at 23° C. in the DIN5 cup.

The surfacer was applied with a wet film thickness of 120 μm to various substrates, allowed to dry for 10 min at RT and then stoved for 25 min at 165° C. Table 3 shows the results of the paint tests.

Further sheets coated with this surfacer and stoved were then coated with a commercial 1-pack acrylate/melamine top coat “Flash Red” from DuPont/Herberts and stoved for 30 min at 130° C. The paint test results are likewise contained in Table 3.

### EXAMPLE A6

Comparison Example to A4); Not According to the Invention

Ex. A5 was repeated except that polyol dispersion and blocked crosslinking agent corresponding to Ex. D12 were used; 23.6 parts by wt. of the aqueous polyol dispersions corresponding to Ex. D12 (without crosslinking agent) and 10.8 parts by wt. of polyisocyanate B4 were ground to a paste with 42.4 parts by wt. of pigment paste P1, 6.5 parts by wt. of a commercial polyester dispersion (Bayhydrol D270, Bayer AG), 3.6 parts by wt. of a commercial melamine resin (Maprenal MF 904, Vianova Resins) and adjusted to a pH of 8.3 with 13.6 parts by wt. of dist. water and to a flow time of 38 seconds at 23° C. in the DIN 5 cup.

The surfacer was applied and tested as in Ex. A5. Table 3 shows the results of the paint tests.

TABLE 3
Paint properties of coatings prepared according to Ex. A4 and A5.

| | | | | | | |
|---|---|---|---|---|---|---|
| Example of appl. | A4 | A4 | A4 | A4 | A5 | A6 |
| Dispersion from Example: | D5 | D6 | D9 | D10 | D11 (comparison) | D12 (comparison |

Surfacer on steel sheet (10 min RT + 25 min 165° C.)

| | | | | | | |
|---|---|---|---|---|---|---|
| Erichsen indent. | >9 | >9 | >9 | >9 | 8.5 | >9 |

Surfacer on glass (10 min RT +25 min 165° C.)

| | | | | | | |
|---|---|---|---|---|---|---|
| Gloss 20°/60° | 66/92 | 67/92 | 68/92 | 58/89 | 32/77 | 59/- |
| Pendulum hardness | 115 | 120 | 120 | 140 | 120 | 119 |
| Solvent resistance | 1012 | 1012 | 2112 | 1012 | 3333 | 2233 |

Surfacer on coating applied by cathodic electrodeposition( 10 min RT+25 min 165°C+1-pack top coat
(30 min 130° C.)

| | | | | | | |
|---|---|---|---|---|---|---|
| VDA stone chip test | 2 | 2-3 | 2 | 2-3 | 3 | 2-3 |
| (2 × 500 g, 2 bar) | | | | | | |
| Adhesion to cath. | Satisf. | Satist. | Satisf. | Satisf. | Satisf. | Satisf. |
| electrodeposition coating | | | | | | |

The paint test results of the stoving surfacer corresponding to Ex. A4 satisfy practical requirements in full. Compared with A5 and A6, solvent resistance, gloss and elasticity (Erichsen elongation) and the test result in accordance with the VDA stone chip test are improved. The viscosity (flow time, DIN4 cup) of the formulated surfacer A6 also increases by 50% after 7 d storage at 40° C., whereas the increase in the comparable formulation A4/D9 is only 25%.

Explanations to the Tests Carried Out

Pendulum hardness: König vibration test DIN 53 157 (s)

Gloss measurement 60° : to DIN EN ISO 2813 (%)

Erichsen indentation: to DIN EN ISO 1520 (mm)

Partial dissolution of paint films: 1 minute contact with the solvents toluene/1-methoxypropylacetate-2/ethyl acetate/acetone at 23° C. Assessment index: each solvent 0-5, Example: 0000=no change, 0005—destroyed with acetone.

VDA stone chip test: in accordance with VW specification, 2×500 g of steel scrap shot at 1.5 bar atmospheric pressure. Index 1-10 (1=no chipping, 10=numerous and very large chips on the sheet metal)

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A waterborne coating composition comprising a physical mixture present in the form of a dispersion in water and optionally organic solvents and comprising
A at least one polyol having urethane groups and chemically bound hydrophilic groups, and
B at least one polyisocyanate having no chemically bound hydrophilic groups and which is blocked with pyrazole derivatives corresponding to formula (I) 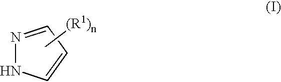
wherein R¹ representsrepresents a (cyclo)aliphatic hydrocarbon radical having 1 to 12, carbon atoms and wherein n is an integer from 0 to 3,
wherein the molar ratio of blocked NCO groups of crosslinking agent B to NCO-reactive groups of polyol A or binder mixtures containing polyol A is 0.2:1 to 5:1.

2. The waterborne coating composition of claim 1 wherein the hydrocarbon radical has 1 to 4 carbon atoms.

3 The waterborne coating composition of claim 1 wherein the polyol A has an average molecular weight Mₙ (calculated from the stoichiometry of the starting material) from 1,600 to 50,000, an acid value from 10 to 80 and a hydroxyl value from 16.5 to 200.

4. The waterborne coating composition of claim 1 wherein the polyol A has a number-average molecular weight Mₙ (calculated from the stoichiometry of the starting material) from 1,600 to 10,000, an acid value from 15 to 40 and a hydroxyl value from 30 to 130.

5. The waterborne coating composition of claim 1 wherein the polyol A is prepared from
A1 5%-80% of at least one organic polyisocyanate
A2 10%-80% of of at least one polyol and/or polyamine with an average molecular weight Mn of at least 400,
A3 2%-15% of at least one compound containing at least two groups which are reactive towards isocyanate groups and at least one group capable of anion formation,
A4 0%-20% of at least one polyol with a molecular weight Mn from 62 to 400,
A5 0%-20% of at least one compound which is monofunctional or contains active hydrogen of varying reactivity, these components being situated in each case at the chain end of the polymer containing urethane groups, and/or
A6 0%-20% of at least one compound which is different from A2, A3, A4 and A5 and contains at least two groups which are reactive towards NCO groups.

6. The waterborne coating composition of claim 5 wherein the amount of
A1 is 10%-60%,
A2 is 36%-70%,
A3 is 3%-10%,
A4 is 1%-10%,
A5 is 0%-20%, and
A6 is 0%-20%.

7. The waterborne coating composition of claim 1 wherein the blocking agent is 3,5-dimethylpyrazole or 3-methylpyrazole.

8. A process for the preparation of the waterborne coating composition of claim 1 wherein the polyisocyanate B is added to the polyol A before or during the conversion thereof to the aqueous phase.

9. A process for the preparation of waterborne coating compositions of claim 1 wherein the crosslinking agent component B is added to the polyol resin A containing urethane and hydroxyl groups before conversion to the aqueous phase and the mixture thus obtained is then dispersed in water.

10. A substrate coated with the waterborne coating composition of claim 1.

11. The substrate of claim 10 wherein the substrate is an automotive substrate.
